(19) United States
(12) Patent Application Publication
(10) Pub. No.: US 2001/0012491 A1
(43) Pub. Date: Aug. 9, 2001

(54) Non-precious alloy and use of same

(76) Inventor: Roland Dieter Strietzel, Lilienthal (DE)

Correspondence Address: Michael B. Lasky, ALTERA LAW GROUP, LLC, Suite 100, 6500 City West Parkway, Minneapolis, MN, 55344-7701, US

(21) Appl. No.: 09/757,932

(22) Filed: Jan. 10, 2001

(30) Foreign Application Priority Data
Jan. 14, 2000 (DE) 100 01 547.6

(51) Int. Cl. A61C 13/08; C22C 19/05

(52) U.S. Cl. 420/452; 433/207

(57) ABSTRACT

What is proposed is a non-precious alloy with a cobalt-chrome or nickel-chrome base containing 30-70% nickel and/or cobalt, 20-35% chrome and 3-25%, in particular 12-15% manganese and/or iron. With such an alloy as casting material, it is possible to make dental products such as crowns, bridges, inlays and the like that can be ceramically veneered without problems arising as a result of different coefficients of thermal expansion.

The invention relates to an alloy with a non-precious metal base (cobalt-chrome or nickel-chrome) and to the use of same as a material for casting dental products such as crowns, bridges, inlays and the like.

Use of a cobalt-chrome alloy for dental casting purposes is known from DE 35 10 331 C1, namely as a material for cast frames and plates for extractable dental prostheses containing at least 20% (by weight) cobalt, 20-35% chrome, 0.3-10.0% manganese and 5-40% iron, as well as 0.1-1.0% carbon and lesser percentages of molybdenum, silicon and nitrogen. In addition, non-precious casting alloys with a cobalt-chrome base and used for dental purposes have been known for decades; using nickel as a partial substitute for cobalt has similarly been known.

The purpose of substituting iron for cobalt, as described in DE 35 10 331 C1, is to achieve the cost savings thus effected. The object of the other alloy components is to offset the 0.2% yield stress that decreases with increasing iron concentration at the expense of the cobalt concentration, without jeopardizing castability and biocompatibility.

What has also been known for decades is that dental castings made from such alloys can be mixed by veneering with ceramics. This technique has been successfully adopted and is used to a considerable extent. Recently, however, problems have arisen from the use of other ceramic materials as veneering materials for non-precious metal dental castings, resulting in difficulties on application to dental products made of known alloys and occasionally rejection. It has now been found that these problems are caused by the other ceramic materials having higher coefficients of thermal expansion. Whereas the coefficient of thermal expansion of conventional alloys and ceramics is approximately 14 (10⁶×K⁻¹), that of new ceramic materials is approximately 16 (10⁶×K⁻¹), Internal stress, cracks and shearing then result, due to the differences in expansion of the materials.

The object of the present invention is to provide a casting alloy particularly for dental purposes, having a coefficient of thermal expansion that is essentially equal to that of the ceramic materials that have been deployed recently, so that these defects do not occur when the alloy is used as a casting material for dental frames and similar.

Said object is achieved by the invention wherein a cobalt-chrome or nickel-chrome alloy contains 30-70% (by weight) nickel and/or cobalt, 20-35% chrome, 3-25%, in particular 12-15% manganese and/or iron, and <0.1, in particular<0.02% carbon. Although the coefficient of thermal expansion of the alloy may also be raised using other elements such as copper, indium, silver, tin or zinc, the sum effect of various factors indicates that iron and manganese are particularly appropriate. These factors include biocompatibility, since iron and manganese are essential elements. In addition, a higher proportion of iron and/or manganese makes the alloy softer and thus provides for enhanced workability; in particular, the alloy according to the invention is characterized by good casting and laser welding properties.

Another aspect concerns the high corrosion resistance of the alloy, which may be further enhanced, like the aforementioned mechanical properties, by adding 4-15% molybdenum and/or 1-15% tungsten and/or niobium. Addition of 0-5% aluminum, lanthanides (rare earths), in particular of cerium and titanium and/or zirconium, is also suitable, as is nitrogenization, for further enhancing the mechanical properties of the alloy, An improvement of the casting properties of the alloy can be achieved by adding silicon, boron and/or germanium in proportions between 0 and 6%; these additives are also suitable as oxygen absorbers and make the alloy interesting for soldering purposes, in particular. A final possibility is to have the alloy contain 0-10% of precious metals, specifically silver, gold and/or metals from the platinum group.

A non-precious alloy pursuant to the invention and suitable as a casting material for dental products such as crowns, bridges, inlays and the like may be comprised as follows:

EXAMPLE 1

| | |
|---|---|
| Cobalt | 50.4% |
| Chrome | 29.0% |
| Manganese | 14.0% |
| Molybdenum | 5.0% |
| Silicon | 1.3% |
| Nitrogen | 0.3% |

EXAMPLE 2

| | |
|---|---|
| Cobalt | 49.0% |
| Chrome | 29.0% |
| Iron | 15.4% |
| Molybdenum | 5.0% |
| Silicon | 1.3% |
| Nitrogen | 0.3% |

1. Non-precious metal alloy with a cobalt-chrome and/or nickel-chrome base containing
30-70% nickel and/or cobalt
20-35% chrome
3-25%, in particular 12-15% manganese and/or iron.

2. Non-precious alloy according to claim 1, characterized by the admixture of 4-15% molybdenum.

3. Non-precious alloy according to claim 1 or 2, further containing, alone or in combination,
4-15% molybdenum
1-15% tungsten and/or niobium
0-6% silicon, boron and/or germanium
0-5% aluminium, titanium, zirconium and/or lanthanides, in particular cerium
<0.1, in particular<0.02% carbon
0-0.4% nitrogen,

4. Non-precious alloy according to one of the claims 1 to 3, characterized in that the manganese and/or iron portion is wholly or partly substituted—alone or in combination—by copper, indium, silver, tin and/or zinc.

5. Use of a non-precious alloy pursuant to one of the preceding claims as a casting material for dental products such as crowns, bridges, inlays and the like.
